(19) United States
(12) Patent Application Publication
(10) Pub. No.: US 2023/0401221 A1
(43) Pub. Date: Dec. 14, 2023

(54) CROSS-TABLES SEARCH METHOD, ELECTRONIC DEVICE, AND STORAGE MEDIUM

(71) Applicant: Beijing Baidu Netcom Science Technology Co., Ltd., Beijing (CN)

(72) Inventors: Lu GAN, Beijing (CN); Zenghui XU, Beijing (CN); Zhiqun XIA, Beijing (CN); Jianbing ZHANG, Beijing (CN); Lianghui CHEN, Beijing (CN); Jian GONG, Beijing (CN); Ke SUN, Beijing (CN)

(21) Appl. No.: 18/063,509

(22) Filed: Dec. 8, 2022

(30) Foreign Application Priority Data
Jun. 9, 2022 (CN) 202210652041.3

(51) Int. Cl. G06F 16/2458; G06F 16/242; G06F 16/2453

(52) U.S. Cl. CPC G06F 16/2458; G06F 16/2433; G06F 16/24542

(57) ABSTRACT

Provided are a cross-tables search method, an electronic device and a storage medium, relating to a field of artificial intelligence, and in particular, to natural language processing, big data, knowledge graph technology, which may be applied in scenarios of smart cloud, smart city, and smart government affairs. The cross-tables search method includes: parsing a query to obtain an entity, attribute and relationship required to be searched; determining a cross-tables search strategy according to the entity, the attribute and the relationship; and performing a cross-tables search operation according to the cross-tables search strategy.

### CROSS-REFERENCE TO RELATED APPLICATIONS

The present application claims priority to Chinese Patent Application No. CN202210652041.3, filed with the China National Intellectual Property Administration on Jun. 9, 2022, the disclosure of which is hereby incorporated herein by reference in its entirety.

### TECHNICAL FIELD

The present disclosure relates to a field of artificial intelligence, and in particular, to natural language processing, big data, knowledge graph technology, which may be applied in scenarios of smart cloud, smart city, and smart government affairs.

### BACKGROUND

Table retrieval is a method for retrieving structural data in the form of tables. Since table data may be used directly, compared with data in other forms such as graphs, table retrieval requires less transformation of existing knowledge, and this search scheme is widely applicable. Table retrieval generally relies on the intentions and attributes understood from the query, and then corresponds to specific tables and fields according to the intentions and attributes.

### SUMMARY

The present disclosure provides a cross-tables search method and apparatus, an electronic device and a storage medium.

According to an aspect of the present disclosure, provided is a cross-tables search method, including: parsing a query to obtain an entity, attribute and relationship required to be searched; determining a cross-tables search strategy according to the entity, the attribute and the relationship; and performing a cross-tables search operation according to the cross-tables search strategy.

According to another aspect of the present disclosure, provided is a cross-tables search apparatus, including: a parsing module configured to parse a query to obtain an entity, attribute and relationship required to be searched; a determining module configured to determine a cross-tables search strategy according to the entity, the attribute and the relationship; and an execution module configured to perform a cross-tables search operation according to the cross-tables search strategy.

According to another aspect of the present disclosure, provided is an electronic device, including: at least one processor; and a memory connected in communication with the at least one processor, where the memory stores an instruction executable by the at least one processor, and the instruction, when executed by the at least one processor, enables the at least one processor to execute the method of any embodiment of the present disclosure.

According to another aspect of the present disclosure, provided is a non-transitory computer-readable storage medium storing a computer instruction thereon, where the computer instruction is used to cause a computer to execute the method of any embodiment of the present disclosure.

According to another aspect of the present disclosure, provided is a computer program product including a computer program, and the computer program implements the method of any embodiment of the present disclosure, when executed by a processor.

The embodiments of the present disclosure may support cross-tables search and may support more complex usage scenarios.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a schematic flowchart of a cross-tables search method according to an embodiment of the present disclosure.

FIG. 2 is schematic flowchart of a cross-tables search method according to another embodiment of the present disclosure.

FIG. 3 is a schematic flowchart of a cross-tables search method according to another embodiment of the present disclosure.

FIG. 4 is a schematic flowchart of a cross-tables search method according to another embodiment of the present disclosure.

FIG. 5 is a structural schematic diagram of a cross-tables search apparatus according to an embodiment of the present disclosure.

FIG. 6 is a structural schematic diagram of a cross-tables search apparatus according to an embodiment of the present disclosure.

FIG. 7 is a schematic diagram of an abstract protocol in an embodiment of the present disclosure.

FIG. 8 is a block diagram of an electronic device for implementing a cross-tables search method according to an embodiment of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize that various changes and modifications may be made to the embodiments described herein without departing from the scope and spirit of the present disclosure. Likewise, descriptions of well-known functions and structures may be omitted in the following descriptions for clarity and conciseness.

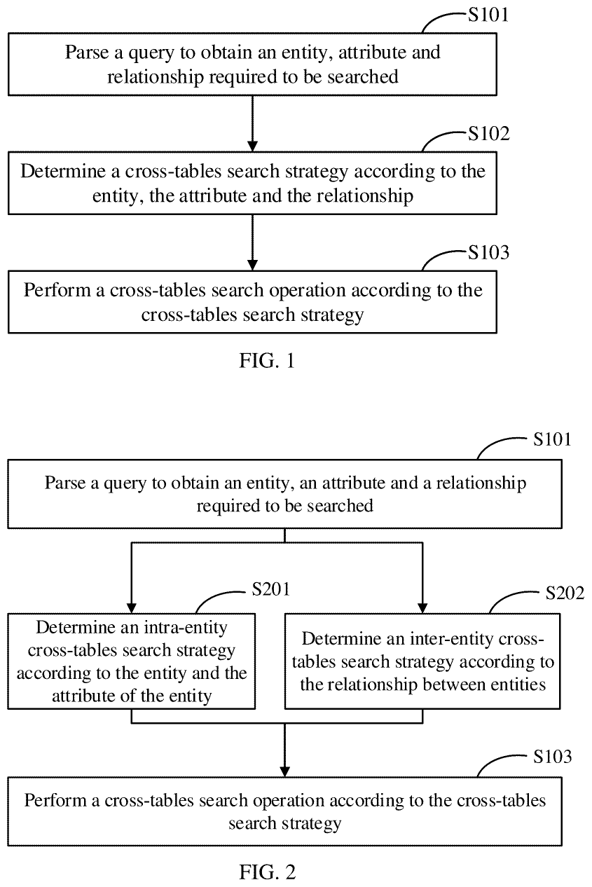

FIG. 1 is a schematic flowchart of a cross-tables search method according to an embodiment of the present disclosure. The method may include the followings.

In S101, a query is parsed to obtain an entity, attribute and relationship required to be searched.

In S102, a cross-tables search strategy is determined according to the entity, the attribute and the relationship.

In S103, a cross-table search operation is performed according to the cross-tables search strategy.

In the embodiments of the present disclosure, a search may also be referred to as retrieval, and a query (Query) may also be referred to as a search request, a retrieval statement, a retrieval request, or the like. The query may include specific content that a user requires to search, such as a plurality of search terms. By parsing the query, the specific entity, attribute and relationship that the user requires to search may be determined. Combinations of different entity relationships may correspond to different intentions. By parsing a query, one or more entities may be obtained, one or more attributes corresponding to each entity may be obtained, and the relationship between different entities may also be obtained. For example, the query is parsed to obtain <entity A, attribute A1, A2>, <entity B, attribute B1, B2, B3>, <entity C, attribute C>, entity A has an R1 relationship with entity B, and entity B has an R2 relationship with entity C.

One or more cross-tables search strategies may be determined according to entities obtained by parsing, each attribute of a respective one of the entities, and the relationship between respective ones of the entities. The cross-tables search strategy may correspond to the cross-tables search operation (or called as cross-tables search behavior) that is required to be performed. For example, a cross-tables search operation that is required to be performed for different cross-tables search strategies is preset by means of a search protocol. After the cross-tables search operation to be performed for the cross-tables search strategy is determined, the cross-tables search operation may be performed in a data source. The searched data source may include an entity table set composed of several entity tables. By parsing the query, the entity, the attribute and the relationship that are required to be searched may be obtained. The cross-tables search operation may be quickly and accurately performed through the cross-tables search strategy determined according to the entity, the attribute and the relationship, thereby supporting cross-tables search and more complex usage scenarios. For example, by setting a cross-tables search strategy through abstract protocol, the intention, the strategy and the data are decoupled, and thus scalability may be better and maintenance costs may be lower. Since the abstract protocol rather than a specific database language is adopted, it may support various types of databases, and the product is more reproducible. In addition, the database type can be automatically adapted through the abstract protocol, and there is no need for escaping development.

FIG. 2 is schematic flowchart of a cross-tables search method according to another embodiment of the present disclosure. The method of this embodiment includes one or more features of the embodiments of the above-mentioned cross-tables search method. In one possible implementation, in S102, determining the cross-tables search strategy according to the entity, the attribute and the relationship, includes the followings.

In S201, an intra-entity cross-tables search strategy is determined according to the entity and the attribute of the entity.

In S202, an inter-entity cross-tables search strategy is determined according to the relationship between entities.

In the embodiments of the present disclosure, an order of performing S201 and S202 is not limited, S201 may be performed first and then S202 may be performed, or S202 may be performed first and then S201 may be performed, or S201 and S202 may be performed in parallel. If the attribute included in each entity are obtained by parsing the query, the intra-entity cross-tables search strategy corresponding to each entity may be determined. The intra-entity cross-tables search strategy may correspond to the intra-entity cross-tables search operation. Since a feature matching field of an entity may appear in a plurality of tables, one or more attributes related to this entity may be searched in a plurality of tables (i.e., entity tables) corresponding to the entity. If there are many attributes of the entity that are required to be searched, which may be distributed in different entity tables, the attributes may be searched in different entity tables separately to perform intra-entity cross-tables search operations. If a plurality of entities and relationships between the entities are obtained by parsing the query, the inter-entity cross-tables search strategy may be determined according to the relationships between the entities. The inter-entity cross-tables search strategy may correspond to the inter-entity cross-tables search operation. After the intra-entity cross-tables search operation corresponding to one entity is performed, the intra-entity cross-tables search operation corresponding to another entity may be performed. Through the intra-entity cross-tables search strategy and the inter-entity cross-tables search strategy, the cross-tables search operation can be supported, and more complex usage scenarios of the plurality of entities can be supported.

In one possible implementation, in S201, determining the intra-entity cross-tables search strategy according to the entity and the attribute of the entity includes: determining a feature matching field corresponding to the entity, and determining an attribute matching field corresponding to the attribute of the entity.

In the embodiments of the present disclosure, each entity may have a feature matching field for uniquely determining the entity. The feature matching field may be preconfigured in the search protocol, and after parsing the entity from the query, the feature matching field corresponding to the entity may be selected. The feature matching field may also be carried in the query and obtained directly by parsing the query. There may be one or more feature matching fields for each entity. Feature matching fields may be different for different types of entities. For example, the feature matching field for a hotel may include “hotel name” and “phone number”, and the feature matching field for a flight may include “flight number” and “home company”. A plurality of attributes of the entity may be parsed according to the query. Based on the attributes of the entity, the attribute matching fields that the entity is required to be searched may be determined. The attribute matching fields to be searched for different entities may be different, or some of them may be the same. The feature match fields and the attribute match fields may be the same as each other, may be partially the same as each other, or may be different from each other. Different attribute matching fields may be distributed in a plurality of entity tables, and may be searched in a plurality of entity tables to obtain the desired result. Through the feature matching field and the attribute matching field, the entity required to be searched and the entity table to which the attribute of the entity pertains may be determined, so that the intra-entity cross-tables search operation may be performed.

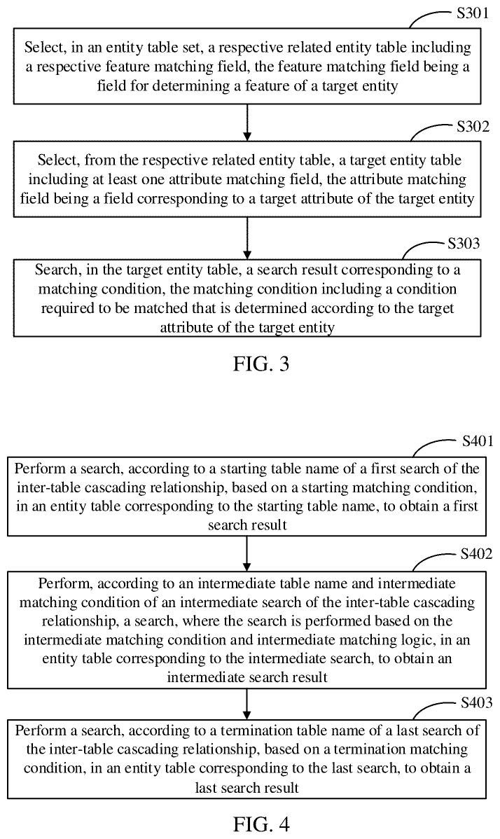

In one possible implementation, as shown in FIG. 3, in S103, performing the cross-tables search operation according to the cross-tables search strategy includes the followings.

In S301, a respective related entity table including a respective feature matching field is selected in an entity table set, the feature matching field being a field for determining a feature of a target entity.

In S302, a target entity table including at least one attribute matching field is selected from the respective related entity table, the attribute matching field being a field corresponding to a target attribute of the target entity.

In S303, a search result corresponding to a matching condition is searched in the target entity table, the matching condition including a condition required to be matched that is determined according to the target attribute of the target entity.

In the case where a quantity of the target entity table is greater than 1, a matching condition of a subsequent target entity table is determined based on a search result of a previous target entity table and an entity attribute involved in the subsequent target entity table. Then, S303 is repeatedly performed.

In the embodiments of the present disclosure, after the intra-entity cross-tables search strategy is determined, a corresponding intra-entity cross-tables search operation may be performed according to the intra-entity cross-tables search strategy. Specifically, one or more target entity tables that meet the requirements may be selected in the entity table set according to each feature matching field of the target entity. If one target entity table is selected, according to the target attribute of the target entity required to be searched, the search result may be obtained by searching in the target entity table according to the matching condition. If a plurality of target entity tables are selected, one or more target entity tables including specific attribute matching fields may be determined according to the target attributes of the target entity required to be searched. If there is only one target entity table, a search operation may be performed according to the matching condition in the target entity table. If there are a plurality of target entity tables, search operations may be serially performed in a plurality of target entity tables, to obtain the search result of the subsequent target entity table, based on the search result of the previous target entity table and the entity attribute involved in the subsequent target entity table. Until all target entity tables are searched, the search result corresponding to the target entity may be obtained. For example, in the entity table set, the related entity tables including the feature matching fields M1 and M2 of entity M are T1 , T2 and T3. The entity table T1 includes the attribute matching field M3 of the entity M, and the entity table T2 includes the attribute matching fields M4 and M5 of the entity M. The entity tables T1 and T2 may be target entity tables corresponding to entities. The search is performed in the entity table T1 according to the matching condition corresponding to the attribute matching field M3, and the search is performed in the entity table T2 according to the matching conditions corresponding to the attribute matching fields M4 and M5.

In the embodiments of the present disclosure, the matching condition (i.e., the attribute matching condition) may be determined according to the attribute required to be searched of the target entity. For example, if an attribute name of an attribute required to be searched for an entity “hotel” is “address” and an attribute value thereof is “XX Road XX Number”, the attribute name and the attribute value may be used as an attribute matching condition. For another example, if an attribute name of an attribute required to be searched for an entity “flight” is “flight date” and the attribute value thereof is “XX month XX day”, the attribute name and the attribute value may be used as an attribute matching condition. Different results may be obtained by selecting the target entity table according to different attribute matching conditions. In addition, the quantity of the attribute matching conditions used by the target entity table may be one or more. The attribute matching conditions used by different target entity tables may be the same as each other, may be partially the same as each other, or may be different from each other.

If there are a plurality of target entity tables for a certain target entity, the plurality of target entity tables may be serially searched. For example, after the search result is obtained based on the attribute matching condition of a previous target entity table, a part of attribute matching condition of a subsequent target entity table may be obtained based on the search result. Alternatively, other attribute matching condition may be added for the subsequent target entity table, and then the subsequent target entity table may be searched.

In the embodiment of the present disclosure, after the related entity table is determined by the feature matching field, a respective target entity table may be further determined from the related entity table according to the attribute matching field, so that the respective target entity table that meets the attribute requirements may be searched separately, to obtain more comprehensive and accurate search result of the target entity.

In one possible implementation, in S202, determining the inter-entity cross-tables search strategy according to the relationship between entities includes: obtaining an inter-table cascading relationship of the plurality of entities according to the relationship between entities.

In the embodiment of the present disclosure, there may be many types of relationships between entities, for example, an occupancy relationship between a person and a hotel, a riding relationship between a person and a flight, and a location ownership relationship between a city and a hotel. The inter-table cascading relationship corresponding to the relationship between entities may be preset. For example, in the riding relationship, it is required to search the basic information table of the flight based on the search result of the basic information table of the person, to obtain the content of the flight related field. For another example, in the location ownership relationship, it is required to search the basic information table of the hotel based on the search result of the basic information table of the city, to obtain the content of the related field of the hotel. After the relationship between entities is obtained by parsing the query, the inter-table cascading relationship corresponding to the relationship between entities may be selected in the preset inter-table cascading relationship based on the relationship between entities. If the quantity of relationships between entities obtained by parsing is in plural, the inter-table cascading relationship corresponding to a respective relationship between entities may be selected separately. By means of the inter-table cascading relationship between a plurality of entity tables, a skip search may be available between entity tables of different entities, thereby supporting complex search scenarios involving more entities.

In one possible implementation, the inter-table cascading relationship includes a table name and search logic for each search. In the case where the relationship between entities is a relationship between a first target entity and a second target entity, the starting table name in the inter-table cascading relationship is a table name of the entity table corresponding to the first target entity, and/or the termination table name in the inter-table cascading relationship is a table name of the entity table corresponding to the second target entity.

In the embodiments of the present disclosure, the inter-table cascading relationship may be described using JSON (JavaScript Object Notation). The inter-table cascading relationship may include fields of a table involved in each search of the relationship between entities, and search logic used to search these fields of the table. The inter-table cascading relationship may also include whether to end or continue to search for the subsequent table after this search, as well as the table name to continue to search, the name of the matching field, the matching condition, and the like. For example, an inter-table search relationship may be expressed as follows: based on a search result of a person basic table, a flight table is searched to determine whether there is flight information for the person “Zhang San”. For another example, an inter-table search relationship may be expressed as follows: based on a search result of a person basic table, a hotel occupancy table is searched for the information of other occupants who stayed in the same hotel with the person “Zhang San” for a certain period. The flight table is searched for the flight number of the other occupants in a certain period based on the other occupant information.

The table name searched for each time in the inter-table cascading relationship may be the table name of the entity table corresponding to the first target entity or the table name of the entity table corresponding to the second target entity. If only one search is required to perform according to the inter-table cascading relationship, the table name searched this time may be both the starting table name and the termination table name. If a plurality of searches are required to perform according to inter-table cascading relationship, it may be capable of searching one by one from the entity table corresponding to the starting table name to the entity table corresponding to the ending table name The search logic of each search in the inter-table cascading relationship may include a matching field required to be searched, a matching manner, and a target field. The matching manner may include, for example, accurate matching, fuzzy matching, semantic matching, relationship matching, range matching, or the like. The target field may include a specific field name required to be output, such as a field name related to the second target entity.

By means of the inter-table cascading relationship, the cross-tables search operation may be performed between different entities, thereby supporting complex search scenarios of a plurality of entities.

In one possible implementation, as shown in FIG. 4, performing the cross-tables search operation according to the cross-tables search strategy includes the followings.

In S401, a search is performed, according to a starting table name of a first search of the inter-table cascading relationship, based on a starting matching condition, in an entity table corresponding to the starting table name, to obtain a first search result, the starting matching condition being determined based on a search result of the first target entity and current search logic.

In the embodiments of the present disclosure, if an inter-table cascading relationship only includes one search, and the first search is also the last search, the matching condition required by the second target entity may be obtained based on the first search result, and then the cross-tables search operation of the second target entity may be performed according to the feature matching field and the attribute matching field of the second target entity (see steps S301 to S303). If an inter-table cascading relationship includes a plurality of searches, the first search result may be used to determine the matching condition of the next search in combination with the next search logic. For example, the field value included in the first search result may be input into the corresponding matching field in the next search logic, and the search may be performed according to the matching manner of the next search logic. By means of the starting matching condition, the search result of the previous search of the first target entity may be combined with the current search logic to perform search in the entity table corresponding to the starting table name related to the first target entity, so that the first target entity may be searched in association with other entities.

In one possible implementation, as shown in FIG. 4, performing the cross-tables search operation according to the cross-tables search strategy further includes the followings.

In S403, a search is performed, according to a termination table name of a last search of the inter-table cascading relationship, based on a termination matching condition, in an entity table corresponding to the last search, to obtain a last search result, the termination matching condition being determined based on a previous search result and current search logic.

In the embodiments of the disclosure, if an inter-table cascading relationship only includes two searches, the termination matching condition of the last search may be determined based on the first search result and the current search logic. For example, the field value included in the first search result may be input into the corresponding matching field in the last search logic, and the search may be performed according to the matching manner of the last search logic.

If an inter-table cascading relationship includes more than two searches, the termination matching condition of the last search may be determined based on the previous intermediate search result and the current search logic. For example, the field value included in the previous intermediate search result may be input into the corresponding matching field in the last search logic, and the search may be performed according to the matching manner of the last search logic.

The matching condition required by the second target entity may be obtained based on the last search result, and then the cross-tables search operation of the second target entity may be performed according to the feature matching field and the attribute matching field of the second target entity (see steps S301 to S303).

By means of the termination matching condition, the previous search results and the current search logic may be combined to perform search in the entity table corresponding to the termination table name related to the second target entity, so that the first target entity and the second target entity may be searched in an association manner.

In one possible implementation, as shown in FIG. 4, in the case where there is at least one intermediate search between the first search and the last search, performing the cross-tables search operation according to the cross-tables search strategy further includes the followings.

In S402, a search is performed, according to an intermediate table name and intermediate matching condition of an intermediate search of the inter-table cascading relationship, where the search is performed based on the intermediate matching condition and intermediate matching logic, in an entity table corresponding to the intermediate search, to obtain an intermediate search result, the intermediate matching condition being determined based on a previous search result and current search logic.

In the embodiments of the present disclosure, an inter-table cascading relationship may include one or more intermediate searches, and S402 may be performed repeatedly. The intermediate matching condition of each intermediate search is determined based on the previous search result and the current search logic. For example, the field value included in the previous search result is input into the corresponding matching field in the current search logic, and the search is performed according to the matching manner of the current search logic.

By means of the intermediate search, it is capable of supporting that the inter-table cascading relationship includes more complex search logic, thereby expanding the complexity of application scenarios for table search.

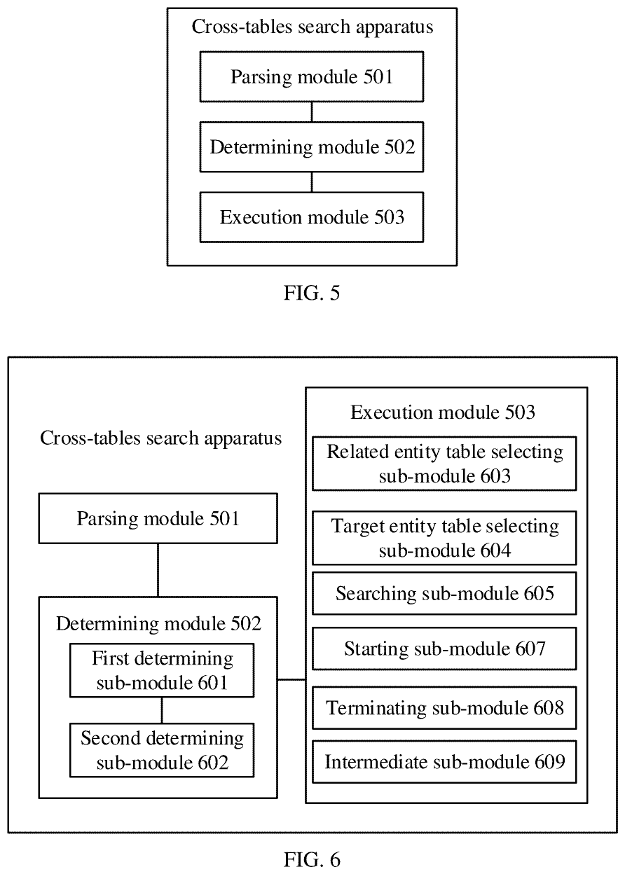

FIG. 5 is a structural schematic diagram of a cross-tables search apparatus according to an embodiment of the present disclosure. The apparatus may include: a parsing module 501 configured to parse a query to obtain an entity, attribute and relationship required to be searched; a determining module 502 configured to determine a cross-tables search strategy according to the entity, the attribute and the relationship; and an execution module 503 configured to perform a cross-tables search operation according to the cross-tables search strategy.

FIG. 6 is a structural schematic diagram of a cross-tables search apparatus according to another embodiment of the present disclosure. The apparatus of this embodiment may include one or more features of the embodiments of the above described cross-tables search apparatus. In one possible implementation, the determining module 502 includes: a first determining sub-module 601 configured to determine an intra-entity cross-tables search strategy according to the entity and the attribute of the entity; and a second determining sub-module 602 configured to determine an inter-entity cross-tables search strategy according to the relationship between entities.

In one possible implementation, the first determining sub-module 601 is configured to determine a feature matching field corresponding to the entity, and determine an attribute matching field corresponding to the attribute of the entity.

In one possible implementation, the execution module 503 includes: a related entity table selecting sub-module 603 configured to select, in an entity table set, a respective related entity table including a respective feature matching field, the feature matching field being a field for determining a feature of a target entity; a target entity table selecting sub-module 604 configured to select, from the respective related entity table, a target entity table including at least one attribute matching field, the attribute matching field being a field corresponding to a target attribute of the target entity; and a search sub-module 605 configured to search, in the target entity table, a search result corresponding to a matching condition, the matching condition including a condition required to be matched that is determined according to the target attribute of the target entity.

In the case where a quantity of the target entity tables is greater than 1, a matching condition of a subsequent target entity table is determined based on a search result of a previous target entity table and an entity attribute involved in the subsequent target entity table.

In one possible implementation, the second determining sub-module 602 is configured to obtain an inter-table cascading relationship of a plurality of entities according to the relationship between entities.

In one possible implementation, the inter-table cascading relationship includes a table name and search logic for each search. In the case where the relationship between entities is a relationship between a first target entity and a second target entity, a starting table name in the inter-table cascading relationship is a table name of a related entity table of the first target entity, and/or a termination table name in the inter-table cascading relationship is a table name of a related entity table of the second target entity.

In one possible implementation, the execution module 503 includes: a starting sub-module 607 configured to perform a search, according to a starting table name of a first search of the inter-table cascading relationship, based on a starting matching condition, in an entity table corresponding to the starting table name, to obtain a first search result, the starting matching condition being determined based on a search result of a first target entity and current search logic.

In one possible implementation, the execution module 503 further includes: a terminating sub-module 608 configured to perform a search, according to a termination table name of a last search of the inter-table cascading relationship, based on a termination matching condition, in an entity table corresponding to the last search, to obtain a last search result, the termination matching condition being determined based on a previous search result and current search logic.

In one possible implementation, the execution module 503 further includes: an intermediate sub-module 609 configured to perform, according to an intermediate table name and an intermediate matching condition of an intermediate search of the inter-table cascading relationship, a search, in the case where there is at least one intermediate search between the first search and the last search, where the search is performed based on the intermediate matching condition and intermediate matching logic, in an entity table corresponding to the intermediate search, to obtain the intermediate search result, the intermediate matching condition being determined based on a previous search result and current search logic.

For the description of the specific functions and examples of respective module and sub-module of the apparatus in the embodiments of the present disclosure, reference may be made to the relevant descriptions of the corresponding steps in the above method embodiments, and thus the repeating description will not be repeated herein.

In the technical solutions of the present disclosure, collection, storage and application of user's personal information involved herein are all in compliance with the provisions of relevant laws and regulations, and do not violate public order and good customs.

The table searches in related technologies are mostly single-table searches, because it is difficult to express the specific inter-table operation from query understanding, and it is also impossible to determine how the data is stored in tables in the term of query understanding, so it is difficult to map. A few cross-tables searches require adopting customized schemes. It is necessary to bind the query intention with the range of the search table and implement the processing logic of each intention in the strategy. In this way, query understanding, search strategy and data management are fully coupled with each other, and the maintenance and expansion costs are very high.

The cross-tables search method provided in the embodiments of the present disclosure is a cross-tables search method based on an abstract protocol, which can greatly expand the complexity of application scenarios of table search and reduce maintenance costs.

The embodiments of the present disclosure may be used in a variety of scenarios, such as smart cloud, smart city, smart government affairs, public security, or the like. If data is distributed in various types of tables in a plurality of departments, the search scheme of the embodiment of the present disclosure can better meet the information search requirement of users.

The cross-tables search method of the embodiments of the present disclosure may further abstract and refine the information required for cross-tables search, communicate among modules at the abstract presentation layer, and decouple query understanding, search strategy and data management from each other, which may make the entire knowledge search system more flexible, greatly reduce maintenance costs, and improve scalability and ease of use.

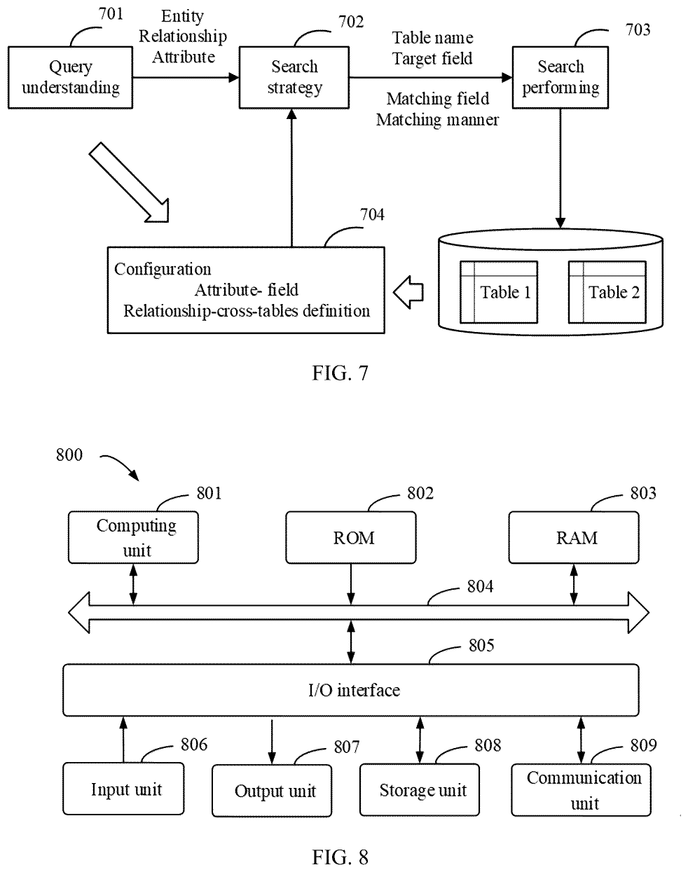

This cross-tables search method can decouple an intention, a strategy and data through the abstract protocol, with better scalability and lower maintenance cost. As shown in FIG. 7, the abstract protocol can mainly involve the following contents.

In 701, an output protocol of query (Query) understanding: in the related technology, the query may understand the intention and the attribute; while according to the present disclosure, the query may understand the entity, the relationship and the attribute. Combinations of different entity relationships correspond to different intentions. The quantity of entities and relationships is much smaller than the quantity of intentions, and the relationship between the attribute and the entity is more realistic, thereby making the design of search strategy more abstract and universal. In addition, the table itself is not based on intention but on entity-based grooming and induction, so the dialogue between query understanding, search strategy, and table management may be more fluent (each module may better understand the upstream and downstream).

In 702, an output protocol of search strategy: in the related technology, the search strategy outputs a database language, such as SQL (Structured Query Language) and DSL (Domain Specified Language). According to the present disclosure, the expression of the search strategy may be abstracted for various kinds of database. For example, the information required for a single-table search may include one or more of table name, target field, matching field (such as feature matching field, attribute matching field, etc.) and matching manner. The cross-tables search process may include performing single-table searches sequentially, so as to be more compatible with different storage medium. By relying on specific search performing methods such as search dependency parallelism and big data cluster computing, the search process may become more flexible and controllable.

In 703, a cross-tables operation strategy protocol (or called as search performing strategy protocol): the main difficulty of cross-tables search is that the cross-tables relationship is difficult to express, and thus the existing cross-tables search is customized

In the embodiments of the present disclosure, a cross-tables behavior may be set as various types, for example, the cross-tables behavior within a single entity and the cross-tables behavior of the relationship between entities. The basic information of table search may include one or more of table name, matching field, and target field. The target field is output from the previous search as the matching field for the next search, so as to implement cross-tables search.

The cross-tables behavior of the entity may be set to select the entity table that matches the attribute condition sequentially, in which the entity table may be automatically selected through the unique field of the entity and the field corresponding to the attribute (the unique field may be contained in a plurality of tables, such as name and ID card).

The cross-tables behavior of the relationship between entities may be described, in JSON, as an inter-table cascading relationship of specifying table name, matching field and target field. The search strategy may be identifiable.

In 704, a table management (registration) protocol (or called as configuration protocol): for changes to table data in related technologies, it is necessary to update intention-table mapping, table-field mapping and field-attribute name mapping simultaneously. According to the present disclosure, it is necessary to maintain only field-attribute name mapping, and the inter-table cascading JSON description of limited relationships (i.e., relationship-cross-tables definition). For example, the JSON description may include two core table names, several core field names, constraints for each search, and so on.

Further, the search method may have the following characteristics during performing.

Data dependency: configuring the mapping relationship between the field name and attribute name of the table, and configuring the cascading between the minimum granularity tables corresponding to the relationship.

Search process: obtaining the entity, the attribute of the entity and the relationship between entities contained in query from the upstream query understanding module, the search strategy parsing the entity, the attribute and the relationship into the abstract search protocol that supports cross-tables, and sending them to the downstream to perform the search operation involved in the search protocol.

In addition to the abstract protocol, the protocol may also be extended to various database interpreters on the basis of a third party, so as to directly support the search of various databases.

An example of a search process may include the followings.
1. The entity is parsed through the query understanding, such as a person.
2. The feature matching field corresponding to the entity is searched according to the configuration. For example, the feature matching field of the person include “name” and “ID number”.
3. All related entity tables (i.e., tables containing these two feature matching fields) of the entity are found out through the feature matching field of the entity. For example, the fields of “name” and “ID number” are included in “people basic table”, “hotel occupancy table”, and other tables, simultaneously.
4. The target entity table in which the fields to be matched (i.e., attribute matching fields) are located is found out from all related entity tables through entity attributes. For example, the matching conditions for the person may include sex “male”, birthplace “XXX”, and occupancy time “XX month XX day”. The fields “sex” and “birthplace” are found out in the person basic table, and the field “occupancy time” is found out in the hotel occupancy table.
5. The search process is performed through the above information, the output target field may include the default field of the target entity table, and all information of the entities that meet the conditions may be returned. The output target field may also be the specified field in the target entity table, and a part of the information of the entity that meets the conditions may be returned. For example, as described above, the above inter-entity cross-tables query process may include: person basic table (sex=male, birthplace=XXX)->hotel occupancy table (name=queried name in the previous table, ID number=queried ID number in the previous table, and hotel occupancy time=XX month XX day).

According to the present disclosure, cross-tables search may be supported and more complex usage scenarios may also be supported. The intention, the strategy and the data are decoupled through abstract protocol, with better scalability and lower maintenance costs. Since the abstract protocol may be adopted and it may support conversion into various types of database languages, the product is more reproducible.

According to the embodiments of the present disclosure, the present disclosure also provides an electronic device, a readable storage medium and a computer program product.

FIG. 8 shows a schematic block diagram of an example electronic device 800 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital processing, a cellular phone, a smart phone, a wearable device and other similar computing devices. The components shown herein, their connections and relationships, and their functions are merely examples, and are not intended to limit implementations of the present disclosure described and/or required herein.

As shown in FIG. 8, the electronic device 800 includes a computing unit 801 that may perform various appropriate actions and processes according to a computer program stored in a read-only memory (ROM) 802 or a computer program loaded from a storage unit 808 into a random access memory (RAM) 803. Various programs and data required for an operation of the electronic device 800 may also be stored in RAM 803. The computing unit 801, ROM 802 and RAM 803 are connected to each other through a bus 804. The input/output (I/O) interface 805 is also connected to the bus 804.

A plurality of components in the electronic device 800 are connected to the I/O interface 805, and include an input unit 806 such as a keyboard, a mouse, or the like, an output unit 807 such as various types of displays, speakers, or the like, a storage unit 808 such as a magnetic disk, an optical disk, or the like, and a communication unit 809 such as a network card, a modem, a wireless communication transceiver, or the like. The communication unit 809 allows the electronic device 800 to exchange information/data with other devices through a computer network such as Internet and/or various telecommunication networks.

The computing unit 801 may be various general-purpose and/or special-purpose processing components with processing and computing capabilities. Some examples of the computing unit 801 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processors, controllers, microcontrollers, or the like. The computing unit 801 performs various methods and processing described above, such as the above cross-tables search method. For example, in some implementations, the above cross-tables search method may be implemented as a computer software program tangibly contained in a computer-readable medium, such as the storage unit 808. In some implementations, a part or all of the computer program may be loaded and/or installed on the electronic device 800 via ROM 802 and/or the communication unit 809. When the computer program is loaded into RAM 803 and executed by the computing unit 801, one or more steps of the cross-tables search method described above may be performed. Alternatively, in other embodiments, the computing unit 801 may be configured to perform the above cross-tables search method by any other suitable means (e.g., by means of firmware).

Various implements of the system and technologies described above herein may be implemented in a digital electronic circuit system, an integrated circuit system, a field programmable gate array (FPGA), an application specific integrated circuit (ASIC), application specific standard parts (ASSP), a system on chip (SOC), a complex programmable logic device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and may transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, so that when executed by the processor or controller, the program code enables the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a random access memory (RAM), a read-only memory (ROM), an erasable programmable read-only memory (EPROM or a flash memory), an optical fiber, a portable compact disc read-only memory (CD-ROM), an optical storage device, a magnetic storage device, or any suitable combination thereof.

In order to provide interaction with a user, the system and technologies described herein may be implemented on a computer that has a display apparatus (e.g., a cathode ray tube (CRT) or a Liquid Crystal Display (LCD) monitor) for displaying information to the user, and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, a computing system (which serves as, for example, an application server) including a middleware, a computing system including a front-end component (e.g., a user computer with a graphical user interface or web browser through which the user may interact with implementations of the system and technologies described herein), or a computing system including any combination of the back-end component, the middleware component, or the front-end component. The components of the system may be connected to each other through any form or kind of digital data communication (e.g., a communication network). Examples of the communication network include a local area network (LAN), a wide area network (WAN), and Internet.

A computer system may include a client and a server. The client and the server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that steps may be reordered, added or removed by using various forms of processes described above. For example, the steps recorded in the present disclosure may be performed in parallel, sequentially, or in a different order, as long as the desired result of the technical scheme disclosed in the present disclosure may be achieved, which is not limited herein.

The foregoing specific implementations do not constitute a limitation to the protection scope of the present disclosure. Those having ordinary skill in the art should understand that various modifications, combinations, sub-combinations and substitutions may be made according to a design requirement and other factors. Any modification, equivalent replacement, improvement or the like made within the spirit and principle of the present disclosure should be included in the protection scope of the present disclosure.

What is claimed is:

1. A cross-tables search method, comprising:
parsing a query to obtain an entity, attribute and relationship required to be searched;
determining a cross-tables search strategy according to the entity, the attribute and the relationship; and
performing a cross-tables search operation according to the cross-tables search strategy.

2. The method of claim 1, wherein determining the cross-tables search strategy according to the entity, the attribute and the relationship comprises:
determining an intra-entity cross-tables search strategy according to the entity and the attribute of the entity; and
determining an inter-entity cross-tables search strategy according to the relationship between entities.

3. The method of claim 2, wherein determining the intra-entity cross-tables search strategy according to the entity and the attribute of the entity comprises:
determining a feature matching field corresponding to the entity; and
determining an attribute matching field corresponding to the attribute of the entity.

4. The method of claim 3, wherein performing the cross-tables search operation according to the cross-tables search strategy comprises:
selecting, in an entity table set, a respective related entity table including a respective feature matching field, the feature matching field being a field for determining a feature of a target entity;
selecting, from the respective related entity table, a target entity table including at least one attribute matching field, the attribute matching field being a field corresponding to a target attribute of the target entity; and
searching, in the target entity table, a search result corresponding to a matching condition, the matching condition including a condition required to be matched that is determined according to the target attribute of the target entity,
wherein in a case of a quantity of the target entity table is greater than 1, a matching condition of a subsequent target entity table is determined based on a search result of a previous target entity table and an entity attribute involved in the subsequent target entity table.

5. The method of claim 2, wherein determining the inter-entity cross-tables search strategy according to the relationship between entities comprises:
obtaining an inter-table cascading relationship of a plurality of entities according to the relationship between entities.

6. The method of claim 3, wherein determining the inter-entity cross-tables search strategy according to the relationship between entities comprises:
obtaining an inter-table cascading relationship of a plurality of entities according to the relationship between entities.

7. The method of claim 4, wherein determining the inter-entity cross-tables search strategy according to the relationship between entities comprises:
obtaining an inter-table cascading relationship of a plurality of entities according to the relationship between entities.

8. The method of claim 5, wherein the inter-table cascading relationship comprises a table name and search logic for each search, and
in a case of the relationship between entities is a relationship between a first target entity and a second target entity, a starting table name in the inter-table cascading relationship is a table name of a related entity table of the first target entity, and/or a termination table name in the inter-table cascading relationship is a table name of a related entity table of the second target entity.

9. The method of claim 6, wherein the inter-table cascading relationship comprises a table name and search logic for each search, and
in a case of the relationship between entities is a relationship between a first target entity and a second target entity, a starting table name in the inter-table cascading relationship is a table name of a related entity table of the first target entity, and/or a termination table name in the inter-table cascading relationship is a table name of a related entity table of the second target entity.

10. The method of claim 7, wherein the inter-table cascading relationship comprises a table name and search logic for each search, and
in a case of the relationship between entities is a relationship between a first target entity and a second target entity, a starting table name in the inter-table cascading relationship is a table name of a related entity table of the first target entity, and/or a termination table name in the inter-table cascading relationship is a table name of a related entity table of the second target entity.

11. The method of claim 8, wherein performing the cross-tables search operation according to the cross-tables search strategy comprises:
performing a search, according to a starting table name of a first search of the inter-table cascading relationship, based on a starting matching condition, in an entity table corresponding to the starting table name, to obtain a first search result, the starting matching condition being determined based on a search result of the first target entity and current search logic.

12. The method of claim 9, wherein performing the cross-tables search operation according to the cross-tables search strategy comprises:
performing a search, according to a starting table name of a first search of the inter-table cascading relationship, based on a starting matching condition, in an entity table corresponding to the starting table name, to obtain a first search result, the starting matching condition being determined based on a search result of the first target entity and current search logic.

13. The method of claim 10, wherein performing the cross-tables search operation according to the cross-tables search strategy comprises:
performing a search, according to a starting table name of a first search of the inter-table cascading relationship, based on a starting matching condition, in an entity table corresponding to the starting table name, to obtain a first search result, the starting matching condition being determined based on a search result of the first target entity and current search logic.

14. The method of claim 11, wherein performing the cross-tables search operation according to the cross-tables search strategy further comprises:
performing a search, according to a termination table name of a last search of the inter-table cascading relationship, based on a termination matching condition, in an entity table corresponding to the last search, to obtain a last search result, the termination matching condition being determined based on a previous search result and current search logic.

15. The method of claim 12, wherein performing the cross-tables search operation according to the cross-tables search strategy further comprises:
performing a search, according to a termination table name of a last search of the inter-table cascading relationship, based on a termination matching condition, in an entity table corresponding to the last search, to obtain a last search result, the termination matching condition being determined based on a previous search result and current search logic.

16. The method of claim 13, wherein performing the cross-tables search operation according to the cross-tables search strategy further comprises:
performing a search, according to a termination table name of a last search of the inter-table cascading relationship, based on a termination matching condition, in an entity table corresponding to the last search, to obtain a last search result, the termination matching condition being determined based on a previous search result and current search logic.

17. The method of claim 14, wherein in a case of there is at least one intermediate search between the first search and the last search, performing the cross-tables search operation according to the cross-tables search strategy further comprises:
performing, according to an intermediate table name and intermediate matching condition of an intermediate search of the inter-table cascading relationship, a search, wherein the search is performed based on the intermediate matching condition and intermediate matching logic, in an entity table corresponding to the intermediate search, to obtain an intermediate search result, the intermediate matching condition being determined based on a previous search result and current search logic.

18. The method of claim 15, wherein in a case of there is at least one intermediate search between the first search and the last search, performing the cross-tables search operation according to the cross-tables search strategy further comprises:
performing, according to an intermediate table name and intermediate matching condition of an intermediate search of the inter-table cascading relationship, a search, wherein the search is performed based on the intermediate matching condition and intermediate matching logic, in an entity table corresponding to the intermediate search, to obtain an intermediate search result, the intermediate matching condition being determined based on a previous search result and current search logic.

19. An electronic device, comprising:
at least one processor; and
a memory connected in communication with the at least one processor;
wherein the memory stores an instruction executable by the at least one processor, and the instruction, when executed by the at least one processor, enables the at least one processor to execute:
parsing a query to obtain an entity, attribute and relationship required to be searched;
determining a cross-tables search strategy according to the entity, the attribute and the relationship; and
performing a cross-tables search operation according to the cross-tables search strategy.

20. A non-transitory computer-readable storage medium storing a computer instruction thereon, wherein the computer instruction is used to cause a computer to execute:
parsing a query to obtain an entity, attribute and relationship required to be searched;
determining a cross-tables search strategy according to the entity, the attribute and the relationship; and
performing a cross-tables search operation according to the cross-tables search strategy.
